(19) United States
(12) Patent Application Publication
(10) Pub. No.: US 2014/0091587 A1
(43) Pub. Date: Apr. 3, 2014

(54) Prospector's shovel

(71) Applicant: Edwin Eric Martin, West Covina, CA (US)

(72) Inventor: Edwin Eric Martin, West Covina, CA (US)

(21) Appl. No.: 13/573,633

(22) Filed: Sep. 28, 2012

(51) Int. Cl. A01B 1/02

(52) U.S. Cl. 294/176

(57) ABSTRACT

An improved shovel tool for gold prospecting specifically in a river configured to reduce or eliminate loss of potentially gold bearing dirt, sand, silt, gravel, or other desirable material due to the river's current passing over the material. Three side-walls extended perpendicularly upward from the perimeter of the scoop's base and a rim projects inward from the top of the side-walls thereby creating a protected pocket within the side-walls and rim of the scoop. The protective pocket traps collected material and water, and forces the river's current to flow around the scoop and collected material, thereby preventing loss.

### CROSS REFERENCE TO RELATED APPLICATIONS

This patent application claims the benefit of and priority to, under 35 U.S.C. 119(e), U.S. Provisional Application entitled “Miner's and Prospector's Shovel and River Shovel/The Gold Digger River Shovel with Sand Trap,” having Ser. No. 61/539,866, filed on Sep. 27, 2011, which is incorporated herein by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### TECHNICAL FIELD

The present invention is in the field of tools used for digging and collecting earth. More specifically, the present invention relates to tools utilized by prospectors to dig and collect various types of earth, including rocks, soil and sand that potentially contain gold or other similarly desirable materials.

### BACKGROUND OF THE INVENTION

Gold prospecting has regained a following in recent years, by professional gold prospectors and hobbyists alike. In that same time, however, the technology for gold prospecting has remained unchanged. This is especially true when it comes to improving tools for digging and collecting earth.

The standard shovel design has remained relatively the same over the years. Most shovels have a handle, a blade for digging and a foot rest for increased power or leverage. While the design is effective for its generally intended use, it is not effective for specialized applications, such as gold prospecting in a river.

One of the main deficiencies in existing shovels is that they allow materials to spill over the side of the shovel and onto the ground. This is generally not a problem when digging a hole. It just means extra scoops must be taken. This is however a problem when gold prospecting in a river because losing or spilling material could mean losing gold.

One particular problem with using a standard shovel in the river is that water currents will wash over the collected sand and dirt as the shovel is being removed from the water and will cause the potentially gold bearing sand and dirt to be washed away. This makes existing shovels highly ineffective.

Over the years, most improvements on shovel technology have been geared towards turning the shovel into a sifter. This is also seen in much of the prior art relating to smaller hand scoops. Generally, prior art in this area incorporates a higher side wall to confine materials within the scoop. However, these improvements are countered by placing specially sized holes in the scoop to allow smaller material to fall through. This too is ineffective for gold prospecting as much of the gold is as fine as or finer than the sand and dirt surrounding it.

By attempting to combined the process of scooping and separating, as is taught in the prior art relating to sifters, they are actually teaching away from the present invention, which seeks not to separate materials, but to trap and collect as much of the intended material as possible.

Therefore, a need exists in this field for a new and useful prospector's shovel capable of digging, trapping and collecting targeted samples of gold bearing sand and dirt from a river with minimal loss or spillage.

### BRIEF SUMMARY OF THE INVENTION

The present disclosure is directed to a tool utilized in prospecting, particularly for gold prospecting in rivers. The prospector's shovel is designed to work in the river and to keep gold bearing sand and gravel trapped within its scoop. The design of the prospector's shovel supersedes typical shovel designs of the past in that it allows for collection of a greater amount of material and traps said material in its scoop to reduce loss or spillage.

One main feature of the prospector's shovel that allows the collection of greater amounts of material is its high vertical sides. The blade of the prospector's shovel is surrounded on the sides and rear by three walls that extend upward from the bottom surface at approximately a 90 degree angle. This allows for a greater amount of material to be collected in each scoop.

Once the desired material is collected, it is important to keep that material in the scoop. This is especially important when prospecting for gold in a river. Rivers generally act as a highway for sand, stones, rocks, and gold. As the river carries these materials downstream there is a tendency for heavier items, like gold, to become trapped in natural deposits sometimes referred to as pay streaks or glory holes. A common example of where gold tends to collect in a river is on the back side of boulders or large rocks and along river bends or in potholes on the floor of the river. Once a prospector has identified a potential gold location, the next step is to dig and collect the potentially gold bearing material.

Digging in a river with a standard shovel comes with a distinct disadvantage. Once a scoop of sand or dirt is taken, it is exposed to the river's current before the prospector has a chance to remove the shovel from the water. This often results in the large amounts of potentially gold bearing sand and dirt, being washed away. Overall this lowers the gold yield for the prospector and means that more scoops must be taken to get extract the same amount of sand and dirt from the river.

With the prospector's shovel, the river's current is diverted around the shovel, thus protecting the freshly scooped sand and dirt, and protecting any gold that may be contained within. The river's current is diverted due to the u-shaped rim that is attached to the side walls, which projects inward at approximately 90 degrees or lower. This rim has the effect of trapping water within the scoop of the prospector's shovel. As the trapped water tries to flow back out of the scoop, it is held the scoop by the current and remains there with the collected material. The river's current then diverts around the trapped water and sand, leaving the collected material in the shovel untouched.

The benefit of using the prospectors shovel is that it eliminates the chance of losing valuable gold bearing sand and dirt, once a potential gold deposit has been located.

### BRIEF DESCRIPTION OF THE SEVERAL VIEWS OF THE DRAWINGS

FIG. 1 is a perspective view of a prospector's shovel 1 according to the present invention.

FIG. 2 is a perspective view of the front of a prospector's shovel 1 according to the present invention.

FIG. 3 is a perspective view of the rear of a prospector's shovel 1 according to the present invention.

### DETAILED DESCRIPTION OF THE INVENTION

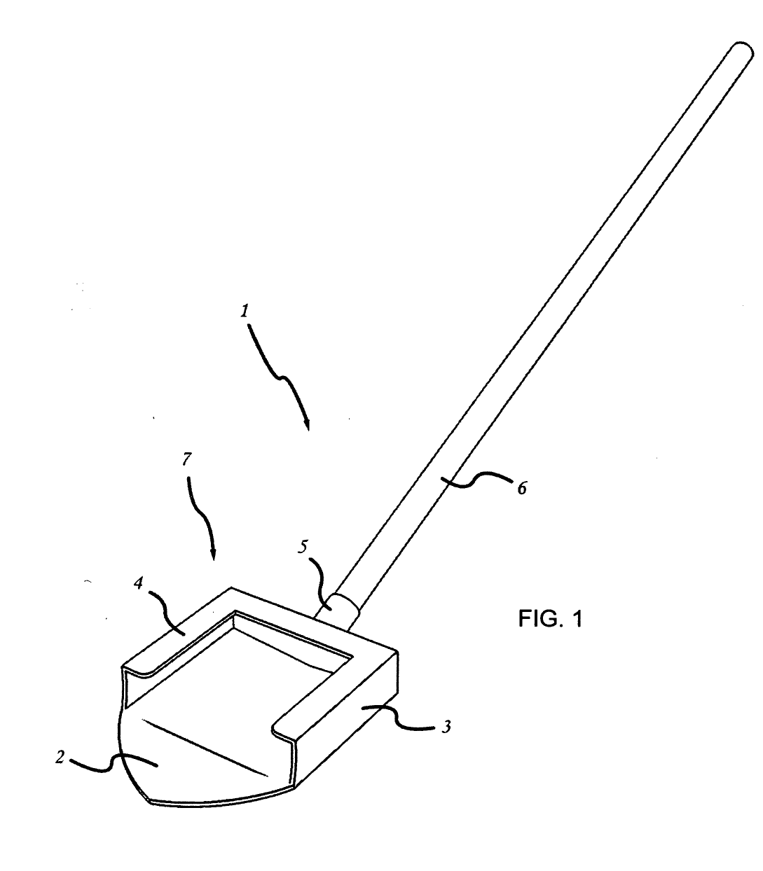

The present disclosure describes a tool for digging and collecting earth, herein referred to as a prospector's shovel 1. The preferred embodiment, as shown in FIGS. 1 through 3, comprises scoop 7 constructed to attach to a handle 6. Scoop 7 is designed to dig in various types of earth medium and to collect and retain said medium in such a manner as to minimize loss or spillage of the collected material thereby increasing a prospector's chances of collecting gold or other desired materials.

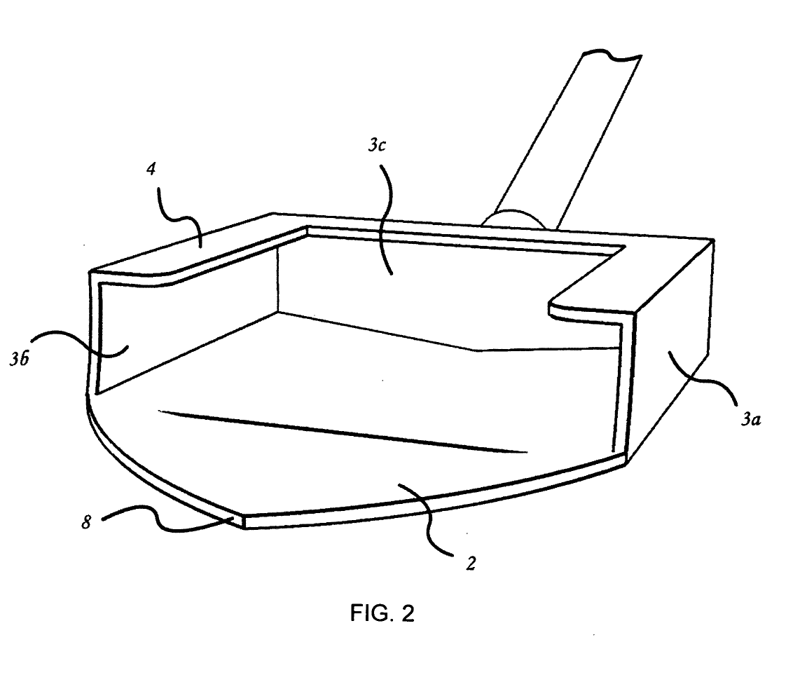

In the preferred embodiment of prospector's shovel 1, shown in FIGS. 1 through 3, scoop 7 comprises several elements. The base of scoop 7 comprises a blade 2. In the preferred embodiment, blade 2 is concaved upward to allow for the collection of a greater amount of material. In an alternate embodiment, blade 2 could be a flat surface. Also in the preferred embodiment, blade 2 comprises a forward facing cutting edge 8 that is pointed, shown in FIG. 2. In an alternate embodiment, cutting edge 8 could be flat, such that the general shape of blade 2 is rectangular or square.

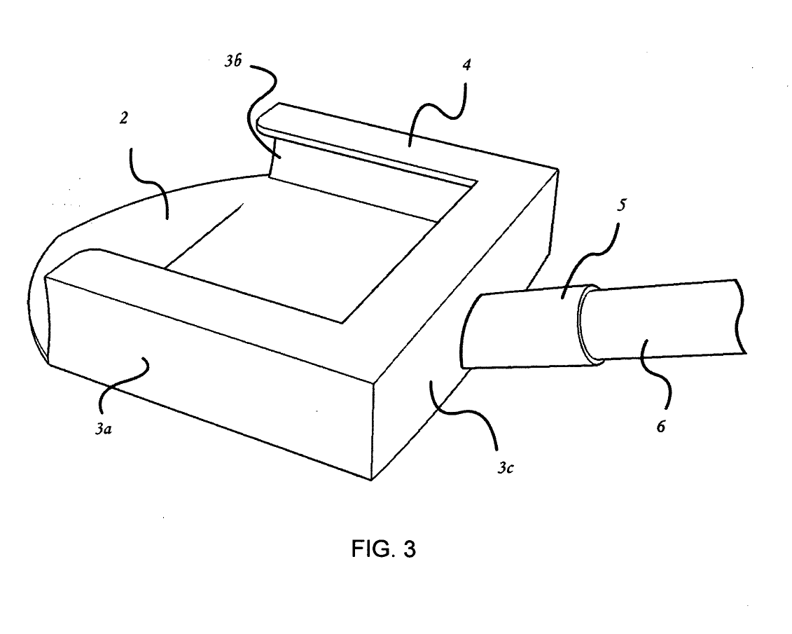

Extending upward from three of the perimeter edges of blade 2 is surrounding wall 3, shown generally in FIG. 1. More specifically, surrounding wall 3 comprises sides 3a, 3b, and 3c, shown in FIGS. 2 and 3. Sides 3a, 3b, and 3c are permanently fixed to blade 2 by their long edges and extend upward in an approximately perpendicular direction. Additionally, one short edge of side 3a is fixed to the first short edge of side 3c forming a corner and one short edge of side 3b is fixed to the second short edge of side 3c forming an opposite corner. Fixed together, sides 3a, 3b, and 3c form a u-shaped wall herein referred to as surrounding wall 3.

Fixed to the top edge of surrounding wall 3 is rim 4, as shown in FIGS. 1 through 3. In the preferred embodiment, rim 4 is a u-shaped unitary structure having a width that extends perpendicularly inward from surrounding wall 3. In an alternate embodiment, rim 4 does not have to extend perpendicularly inward, but may extend at a downward angle and still achieve the desired utility.

In the preferred embodiment, blade 2, sides 3a, 3b, and 3c, and rim 4 are fixed as described above by welding the appropriate edges. In an alternate embodiment, rim 4 could be formed by bending sides 3a, 3b and 3c inward to the desired angel. Still in another embodiment, scoop 7 could be a unitary structure formed from a single piece of material, by bending sides 3a, 3b, and 3c into their desired perpendicular positions and then bending each a second time inward to the desired angle to form rim 4.

The preferred embodiment also comprises receiving socket 5 permanently affixed to the flat outer surface of side 3c. In the preferred embodiment, receiving socket 5 is affixed to side 3c at an angle of approximately 20 degrees above perpendicular. Alternate embodiments may utilize an angle greater or less than 20 degrees and still achieve the desired utility.

Inserted into receiving socket 5 is handle 6. In the preferred embodiment, handle 6 is slideably retained in socket 5 by at least one fastener passing through the diameter of sleeve 5 and handle 6. In an alternate embodiment, adhesive may be used to retain handle 6, or handle 6 may be threaded and screw into a receiving thread within receiving socket 5. Additionally, as shown in the present embodiment, handle 6 is unitary piece. In an alternate embodiment, handle 6 can be broken down into two or more pieces to convenient transport and storage.

In the preferred embodiment, scoop 7 is made from hardened steal. Alternatively, shovel head 7 can be made from any material with sufficient strength and rigidity necessary to dig and collect the various earth medium. In the preferred embodiment, handle 6 is made of wood. Alternate embodiments, may use any material of sufficient strength and rigidity, such as aluminum.

Although the present invention has been described in accordance with the embodiment shown and contains many specifics, these descriptions should not be construed as limiting the spirit of the invention or scope of the appended claims.

1. A prospector's shovel apparatus, the apparatus comprising:
a blade, said blade having a bottom portion and at least three sidewalls extending upwards from, and substantially perpendicular to, said bottom portion to form a scoop, each sidewall having an internal and external vertical surface;
a rim extending inward from said internal vertical surface of each said sidewall to form a top portion, said top portion having at least three edges and a gap, said gap being defined by said edges;
at least one receiving socket extending outward from said external vertical surface of at least one sidewall; and
a handle, said handle being joined to said receiving socket.

2. The apparatus of claim 1 wherein:
said bottom surface is substantially flat.

3. The apparatus of claim 2 wherein:
said rim extending inward is substantially perpendicular to each said sidewall.

4. The apparatus of claim 2 wherein:
said rim extends inward and downward, forming an acute angle angel between said rim and said sidewalls.

5. The apparatus of claim 1 wherein:
said bottom surface is concaved upward.

6. The apparatus of claim 5 wherein:
said rim extending inward is substantially perpendicular to each said sidewall.

7. The apparatus of claim 2 wherein:
said rim extends inward and downward, forming an acute angle angel between said rim and said sidewalls.
